(19) United States
(12) Patent Application Publication
(10) Pub. No.: US 2024/0006968 A1
(43) Pub. Date: Jan. 4, 2024

(54) METHOD FOR PRODUCING A ROTOR OF AN ELECTRIC MACHINE

(71) Applicant: MAHLE International GmbH, Stuttgart (DE)

(72) Inventor: Christoph Steinmetz, Ludwigsburg (DE)

(21) Appl. No.: 18/215,810

(22) Filed: Jun. 28, 2023

(30) Foreign Application Priority Data
Jun. 29, 2022 (DE) 10 2022 206 607.3

(51) Int. Cl. H02K 15/16; H02K 7/04

(52) U.S. Cl. CPC H02K 15/165; H02K 7/04

(57) ABSTRACT

A method for producing a rotor of an electric machine is disclosed. The method may include providing at least two individual parts and individually balancing the at least two individual parts. The method may also include, subsequently to balancing the at least two individual parts, connecting the at least two balanced individual parts to one another such that the rotor is at least unbalance-low.

### CROSS-REFERENCE TO RELATED APPLICATION

This application claims priority to German Patent Application No. DE 10 2022 206 607.3, filed on Jun. 29, 2022, the contents of which is hereby incorporated by reference in its entirety.

### TECHNICAL FIELD

The present invention relates to a method for producing a rotor of an electric machine. In addition, the invention relates to a rotor of an electric machine that has been produced according to the said method and to an electric machine having a rotor produced in such a manner.

### BACKGROUND

Electric motors are known to have rotors and are increasingly also employed in motor vehicle construction for driving the same, for example in electric vehicles or hybrid vehicles. In order to be able to achieve a smooth operation and also a high wear resistance, the rotors of these electric motors are usually balanced in that for example balancing weights to be specifically attached and/or removed reduce or entirely eliminate a detected unbalance.

From DE 10 2013 215 080 A1 a method for balancing a rotor of an electric motor is known, wherein the rotor is constructed of a number of disc-shaped rotor elements and a rotor shaft carrying the disc-shaped rotor elements. The disc-shaped rotor elements each have a central bore which serves to receive the rotor shaft at least part-circumferentially. The balancing method takes place as follows: initially, a rotor assembly consisting of the disc-shaped rotor elements is formed and an assembly unbalance present for this rotor assembly determined. Following this, an assembly unbalance feature is provided which represents the assembly unbalance present in the rotor assembly. Again following this, a shaft unbalance present for the rotor shaft is determined and a shaft unbalance feature established which represents the shaft unbalance present for the rotor shaft. When assembling the rotor, the rotor assembly and the rotor shaft are now aligned with one another and connected to one another as a function of the assembly unbalance feature and of the shaft unbalance feature. This is to make possible a simplified balancing of the rotor with reduced balancing weights.

Usually, the current rotor balancing procedure is as follows: initially, the individual parts of the rotor, for example end pieces as well as a tubular shaft centre piece and rotor laminations are connected to one another, usually even without defined orientation relative to one another, wherein following the assembly of the rotor the same is then balanced as a whole. This takes place by means of balancing weights which are attached in suitably determined places or removed from these.

However, disadvantageous in this procedure is that the balancing of the rotor takes place only after the assembly of the same so that faults caused by the unbalance, which can no longer be rectified, result in the entire rotor being discarded, which is comparatively expensive.

### SUMMARY

The present invention therefore deals with the problem of stating a method for producing a rotor of an electric machine which in particular reduces a scrap rate.

According to the invention, this problem is solved through the subject matter of the independent claim(s). Advantageous embodiments are the subject matter of the dependent claim(s).

The present invention is based on the general idea, other than is usual to date, to assemble a rotor of an electric machine for example of an electric motor or a generator initially from unbalanced individual parts and balance the assembled rotor only following this, but according to the invention individually balance the individual parts of the rotor, in particular also combined into preassembly groups, prior to their actual assembly to form the rotor, as a result of which the risk of an intolerable unbalance of the assembled rotor and thus the scrapping of the same can be reduced. With the method according to the invention for producing the rotor of the electric machine, initially at least two individual parts are thus provided and individually balanced. Following this, these two balanced individual parts are connected to one another in such a manner that the rotor is at least unbalance-low, or preferentially even unbalance-free. It is obviously clear that such a rotor cannot only consist of two individual parts but of a multiplicity of such individual parts, wherein with the method according to the invention at least a predominant quantity, preferentially all individual parts and/or preassembly groups of these are balanced beforehand, i.e. prior to their assembly. Assembling already balanced individual parts thus reduces the risk of an intolerable unbalance of the rotor in the fully assembled state quite substantially, as a result of which a scrap rate of fully assembled rotors can be significantly reduced and thus the production of such rotors be rendered significantly more cost-effectively. Should, in the process, some of the individual parts have still tolerable unbalances, an assembly of the rotor according to the invention is additionally possible in such a manner that the individual parts are rotated with respect to an axis of rotation of the rotor relative to one another in such a manner that any unbalances that are still present and very minor are further counterbalanced. The method according to the invention additionally offers the major advantage that complex individual parts can be separately produced and balanced which, compared with a balancing of the entire fully assembled rotor performed to date, is significantly simpler in terms of production.

In an advantageous further development of the method according to the invention, at least one tubular shaft centre piece and a first end piece and a second end piece are provided as individual parts and individually balanced. Following this, the two end pieces are connected to the tubular shaft centre piece in such a manner that the rotor shaft being created from this and/or a rotor assembled from this is at least unbalance-low. Preferentially, all individual parts, i.e. the two end pieces and the tubular shaft centre piece, are thus already balanced prior to their assembly and thus preferentially even unbalance-free, as a result of which an unaligned assembly of the individual parts is possible without imbalances being created on the fully assembled rotor in the process. Should the individual parts still have minor yet tolerable unbalances it is possible to rotate these with respect to an axis of rotation relative to one another during the assembly to form the finished rotor shaft and/or during the assembly to form the finished rotor in such a manner that the individual unbalances of the individual parts counterbalance one another in the assembled rotor.

In an advantageous further development of the method according to the invention, at least one rotor lamination, a balancing disc, a magnet, a shaped body and/or windings are provided as individual parts and individually balanced. The mentioned balancing disc is usually omitted but can be optionally provided. Following this, the at least one rotor lamination, the at least one optional balancing disc, the at least one magnet, the shaped body and/or the windings are connected to the two end pieces and the tubular shaft centre piece in such a manner that the rotor composed of these is at least unbalance-low. Even this partial listing shows the manifold possibilities of individual parts that are possible for the method according to the invention, so that a rotor produced by means of the method according to the invention can purely theoretically be assembled also from ten, twenty or more individual parts, which in accordance with the method according to the invention however can be individually balanced prior to the assembly provided these are not combined into practical preassembly groups in order to thereby, for example due to an unbalance fault, at least reduce the scrap rate of fully assembled rotors. With respect to the balancing discs it must be said that balancing can take place for example by way of a material removal provided by a balancing disc. This means when on the individual parts themselves no “reworking” is possible, balancing discs are needed. The same applies to the adding of weight elements for balancing. Here, too, material is needed into which such additional weights can be introduced.

In a further advantageous embodiment of the method according to the invention, at least the two end pieces are rotated or aligned relative to one another prior to being connected to the tubular shaft centre piece about an axis of rotation of the rotor in such a manner that the rotor assembled from these is at least unbalance-low. This offers the major advantage that the individual parts that are axially already balanced per se, provided these still have unexpected minor unbalances, can be arranged relative to one another by an angle of rotation-dependent arrangement in such a manner that individual unbalances of the respective individual parts can still be counterbalanced. In the same manner, obviously all individual parts can be aligned relative to one another with regard to any unbalances that may still be present during the assembly of the rotor.

In a particularly preferred embodiment of the method according to the invention, the end pieces are screwed together with the tubular shaft centre piece. This can take place by means of tie rods, wherein in this case under certain conditions at least one balancing disc has to be provided in order to be still able to counterbalance unbalances resulting from such tie rods. A screwed-together rotor offers the major advantage that the same can be unscrewed for maintenance or repair purposes, as a result of which the replacement of individual parts is also comparatively easily possible. This is particularly advantageous in particular with a view to an ecological design, saving of resources and sustainability.

In a particularly preferred alternative embodiment of the method according to the invention, the end pieces are glued together with the tubular shaft centre piece. This offers the possibility of a comparatively simple and quick connection technique. Alternatively, a pressing together of the end pieces with the tubular shaft centre piece or a welding together of the same is obviously also possible.

The present invention, further, is based on the general idea of producing a rotor of an electric machine with the method described in the preceding paragraphs. By way of this it is possible to transfer the advantages described with respect to the method to the rotor. Concretely, these are in particular a significantly reduced scrap rate.

Further, the present invention is based on the general idea of equipping an electric machine with a rotor described in the preceding paragraph. This offers the particular advantage that because of the scrap rate of produced rotors reduced with the method according to the invention, the scrap rate of the electric machines is also reduced.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention. Parts mentioned above and still to be named in the following of a higher unit, such as for example an installation, a device or an arrangement which are separately designated, can form separate components of this unit or be integral regions or portions of the said unit, even if such is shown differently in the drawings.

Preferred exemplary embodiments of the invention are shown in the drawings and are explained in more detail in the following description.

### BRIEF DESCRIPTION OF THE DRAWINGS

There it shows, in each case schematically:

FIG. 1 shows a flow diagram of a method according to the invention,

FIG. 2 shows a sectional representation through a rotor of an electric machine produced in accordance with the method according to the invention.

### DETAILED DESCRIPTION

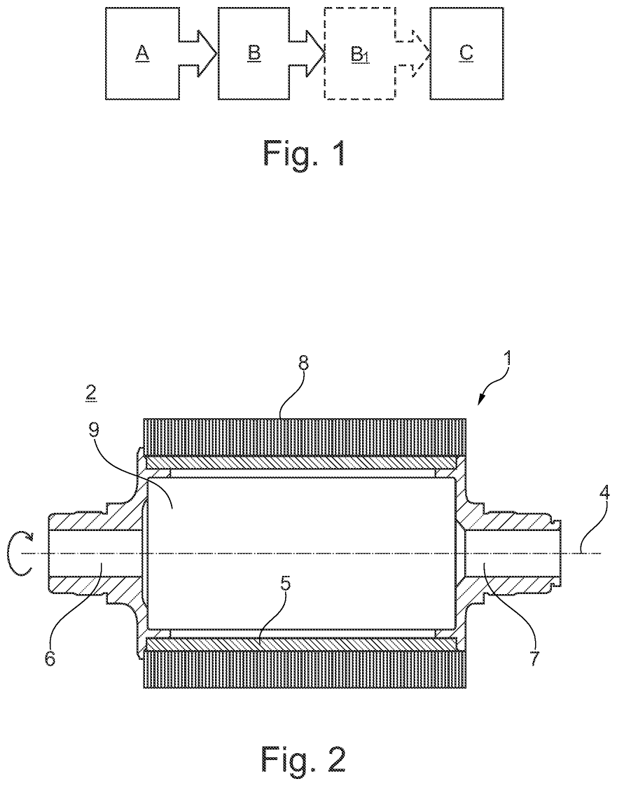

With a method according to the invention for producing a rotor 1 (see FIG. 1) of an electric machine 2 according to FIG. 1, in particular of an electric motor or of a generator, initially at least two individual parts 3 are provided in a method step A and subsequently balanced individually in a method step B. Following this, the at least two balanced individual parts 3 are connected to one another in the method step C in such a manner that the rotor 1 assembled from these is at least unbalance-low or is preferentially even unbalance-free. Because of the separate balancing of the individual parts 3 according to the invention it is possible to balance these even prior to the actual assembly to form the rotor 1 and because of this avoid both an elaborate balancing of the entire rotor 1 and also reduce a scrap rate of already fully assembled rotors 1 because of unbalancing faults that cannot be counterbalanced.

Between the method steps B and C a method step Bi can be additionally carried out which according to FIG. 1 is represented by a dashed drawn line and thus merely provided purely optionally. In the method step Bi, the two individual parts 3 already balanced individually can be arranged rotated relative to one another about an axis of rotation 4 (see FIG. 2) prior to being connected or assembled in the method step C in such a manner that any unbalances of the individual parts 3 that may still exist under certain conditions can be further reduced by the arrangement aligned relative to one another.

With the method according to the invention it is additionally possible to tolerate larger unbalance tolerances of the individual parts 3 and separately produce and balance complex individual parts 3 which compared with a balancing of the entire fully assembled rotor 1 performed in the past, is significantly simpler in terms of production.

As individual parts 3, a tubular shaft centre piece 5 and a first end piece 6 and a second end piece 7 can be employed for example. However, as individual parts, rotor laminations 8, a shaped body 9, magnets and/or windings or a balancing disc can be additionally be employed. Independently of the respective embodiment of the individual parts 3, these are balanced individually and/or combined into a preassembly group, prior to being assembled to form the rotor 1.

The end pieces 6, 7 can be screwed together with the tubular shaft centre piece 5, as a result of which a maintenance and repair-friendly rotor 1 can be created. Alternatively it is obviously also conceivable that the end pieces 6, 7 are glued, pressed and/or welded together with the tubular shaft centre piece 5.

With the method according to the invention it is possible to recognise and separate any existing scrap at an early stage, i.e. even at the state of the individual parts 3 so that such faulty scrap parts are no longer utilised or employed for assembling the rotor 1, as a result of which the scrap rate of the rotors 1 can be significantly lowered.

The shaft centre piece 5 serves as carrier of the rotor laminations 8 and for torque transmission as required, wherein the torque transmission can also take place by a one-piece or multi-part shaped body 9, which is arranged within the shaft centre piece 5.

1. A method for producing a rotor of an electric machine, comprising:
providing at least two individual parts;
individually balancing the at least two individual parts, and
subsequently to individually balancing the at least two individual parts, connecting the at least two balanced individual parts to one another such that the rotor is at least unbalance-low.

2. The method according to claim 1, wherein:
the at least two individual parts includes at least one tubular shaft centre piece, a first end piece, and a second end piece; and
connecting the at least two balanced individual parts includes connecting the first end piece and the second end piece to the at least one tubular shaft centre piece such that the rotor is at least unbalance-low.

3. The method according to claim 2, wherein:
the at least two individual parts further includes at least one of at least one rotor lamination, at least one balancing disc, at least one magnet, a shaped body, and a plurality of windings; and
connecting the at least two balanced individual parts further includes connecting the at least one of the at least one rotor lamination, the at least one balancing disc, the at least one magnet, the shaped body, and the plurality of windings to the first end piece, the second end piece, and the at least one tubular shaft centre piece such that the rotor is at least unbalance-low.

4. The method according to claim 2, further comprising, prior to connecting the first end piece and the second end piece to the at least one tubular shaft centre piece, aligning the first end piece and the second end piece about an axis of rotation of the rotor such that the rotor is at least unbalance-low.

5. The method according to claim 2, wherein connecting the first end piece and the second end piece to the at least one tubular shaft centre piece includes screwing the first end piece and the second end piece together with the at least one tubular shaft centre piece.

6. The method according to claim 2, wherein connecting the first end piece and the second end piece to the at least one tubular shaft centre piece includes gluing the first end piece and the second end piece to the at least one tubular shaft centre piece.

7. The method according to claim 2, wherein connecting the first end piece and the second end piece to the at least one tubular shaft centre piece includes pressing the first end piece and the second end piece together with the at least one tubular shaft centre piece.

8. The method according to claim 2, wherein connecting the first end piece and the second end piece to the at least one tubular shaft centre piece includes welding the first end piece and the second end piece together with the at least one tubular shaft centre piece.

9. A rotor of an electric machine produced according to the method of claim 1.

10. An electric machine, comprising the rotor according to claim 9.

11. The method according to claim 1, wherein the rotor is unbalance-free.

12. The method according to claim 1, further comprising, when at least a subset of the at least two balanced individual parts have tolerable unbalances, counterbalancing the tolerable unbalances via rotating at least some of the at least two balanced individual parts relative to one another around an axis of rotation of the rotor.

13. The method according to claim 12, wherein counterbalancing the tolerable unbalances is performed prior to connecting the at least two balanced individual parts.

14. The method according to claim 5, wherein the first end piece and the second end piece are screwed to the at least one tubular shaft centre piece via a plurality of tie rods.

15. The method according to claim 14, wherein:
the plurality of individual parts further includes at least one balancing disc; and
the method further comprises counterbalancing unbalances resulting from the plurality of tie rods with the at least one balancing disc.

16. A method for producing a rotor of an electric machine, comprising:
providing a plurality of individual parts;
balancing the plurality of individual parts; and
subsequently to balancing the plurality of individual parts, connecting the plurality of balanced individual parts to one another such that the rotor is at least unbalance-low.

17. The method according to claim 16, further comprising combining a subset of the plurality of individual parts to form a subassembly group.

18. The method according to claim 17, wherein balancing the plurality of individual parts includes individually balancing a remainder of the plurality of individual parts and the subassembly group.

19. The method according to claim 16, wherein:
the plurality of individual parts includes a tubular shaft centre piece, a first end piece, and a second end piece; and
connecting the plurality of balanced individual parts includes connecting the first end piece and the second end piece to the tubular shaft centre piece.

20. The method according to claim 19, wherein:
the plurality of individual parts further includes at least one rotor lamination, at least one magnet, at least one shaped body, and at least one winding; and
connecting the plurality of balanced individual parts further includes connecting the at least one rotor lamination, the at least one magnet, the at least one shaped body, and the at least one winding to at least one of the first end piece, the second end piece, and the tubular shaft centre piece.
